(19) United States
(12) Patent Application Publication
(10) Pub. No.: US 2005/0237691 A1
(43) Pub. Date: Oct. 27, 2005

(54) Small geometry pads and system for wireless power supply

(76) Inventors: Tal Dayan, Los Gatos, CA (US); Dan Kikinis, Saratoga, CA (US); Pandurangan Ramakrishnan, Palo Alto, CA (US); Victor C. Su, Palo Alto, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/690,076

(22) Filed: Oct. 20, 2003

Related U.S. Application Data
(60) Provisional application No. 60/419,441, filed on Oct. 18, 2002.
(60) Provisional application No. 60/421,216, filed on Oct. 24, 2002.
(60) Provisional application No. 60/421,216, filed on Oct. 24, 2002.

(51) Int. Cl. H02H 1/04

(52) U.S. Cl. 361/119

(57) ABSTRACT

An apparatus comprising a mobile electronic device having two electrical contact zones, the mobile device to be placed on a pad having two contact zones corresponding to the two contact zones of the telephone, the pad receiving electrical power from a power supply, when the two contact zone of the telephone are placed in contact with the two contact zones of the pad an electrical circuit is established.

This application claims priority to provisional application No. 60/419,441 filed Oct. 18, 2002 titled “Small Geometry Pads and System For Wireless Power Supply” (attorney docket no. 6041.P010z) and to provisional application No. 60/421,216 filed Oct. 24, 2002 titled “Non Homogenous Zones In A Free Positioning Power Transfer” (attorney docket no. 6041.P011z). Both provisional applications are herein incorporated by reference.

### BACKGROUND

Although the system described in previous co-pending provisional application titled “Enhanced Contact Systems For Surfaces And Devices” filed Sep. 25, 2002, Attorney Docket No. 6041.P009z, application No. 60/413,791, which is incorporated by reference, of which this disclosure is related, is very useful, sometimes only certain aspects of its novel art are required in a low-end, limited-usage application. In particular, for very inexpensive, low-end devices, it may be wasteful to integrate a full system into the basic product.

What is clearly needed in such cases is a simplified, basic pad that allows the user to start with a low-cost minimum solution, but also allows system upgrades at a later time.

In addition, in some cases, devices may vary wildly, both in size and in electrical requirements. For example, a cell phone may have substantially different geometry from a notebook computer, and a PDA may differ likewise from both of these previous devices. Therefore, the geometry of a contact pad that is suitable for a cell phone or a PDA may not be suitable for a notebook, and vice versa.

In particular, a small cell phone may require densely spaced contact zones (i.e. an area with possibly a multitude of contact points, but all electrically connected together and controlled by a “single contact” node as described earlier), with a correspondingly great number of contacts. Thus, for a notebook-sized pad such dense contact spacing becomes uneconomical, due to the large total number of contact zones (potentially several hundred). For example, if a grid on a pad for a cell phone requires a one-inch center-to-center between distinct contact zones (one contact area may contain several contact points), then a desktop pad of 20×40 inches would require 800 contact zones, which would be prohibitively expensive. What is clearly needed is a multi-zone approach that has different contact-area densities in different zones, and the different zones may be indicated by accordingly different colors.

Furthermore, in some cases, upgrade ability by attaching a contact interface to a docking port in lieu of a power input port or a connector that was designed to allow attaching of the adapter to the device, or any other suitable connector able to insert power into a device.

### BRIEF DESCRIPTION OF DRAWINGS

FIG. 1 shows a mobile electronic device, such as a mobile telephone;

FIG. 2 shows the phone on pad;

FIG. 3 shows another embodiment;

FIG. 4 illustrates a phone 310 set down onto pad;

FIG. 5 shows a pad with multiple zones;

FIG. 6 shows different cell phone positions on a pad; and

FIG. 7 shows such an approach wherein the first matrix array switch takes voltages from a power supplier lines.

### DESCRIPTION OF THE EMBODIMENT

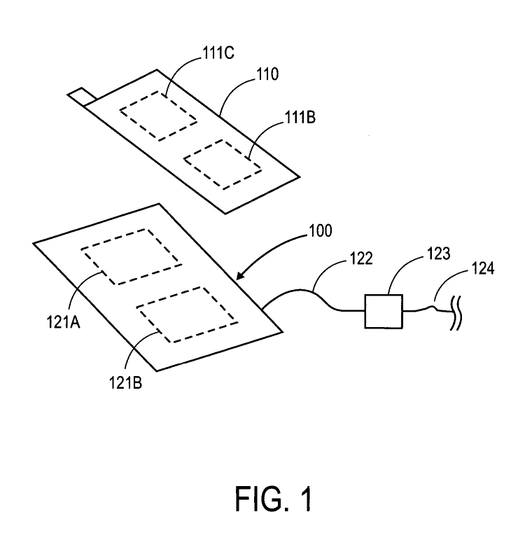

FIG. 1 shows a mobile electronic device, such as a mobile telephone 110. It has two contact zones 111a and 111b, as described in the previous co-pending applications. Instead of a full pad with many zones, in this case the system has only a small pad 100 with only two contact zones, 121a and 121b. Power supply 123 may be a very basic power supply, or even the standard power supply of current art that is sold with the device 110. It may have only limited capabilities or even only capabilities to operate that one single device. In some cases, such a small pad can be integrated in a larger equipment such as car dashboard, furniture, treadmills, etc.

The user simply puts the phone 110 down onto pad 100, thus establishing an electrical circuit.

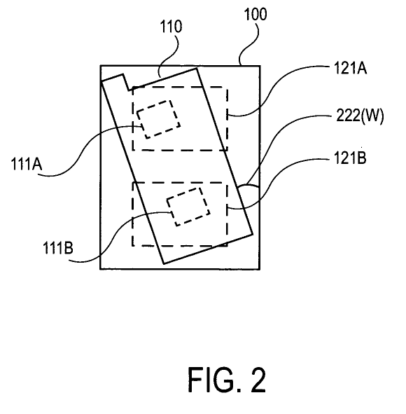

FIG. 2 shows the phone 110 on pad 100. It is clearly visible that phone contacts 111a and 111b are aligned with pad contacts 121a and 121b. The angle omega 222 between device main axis and the pad main axis does not have to be exactly zero degrees. Omega 222 may be 10 degrees, 20 degrees, or even as great as 45 degrees. In some cases, it can also be rotated by 180 degrees in addition to the slight angles mentioned above.

In some cases, pad 100 may be bounded by a small frame (not shown) to limit the range of omega 222. That frame may have an opening to accommodate protruding features that are characteristics of the device, such as the antenna, so that placing the device in the frame with the protruding features in the corresponding opening would also restrict the omega 222, without, at the same time, requiring precise insertion, as would typically be required when a device such as phone 110 is inserted into a charging cradle (not shown) of the type used in current art.

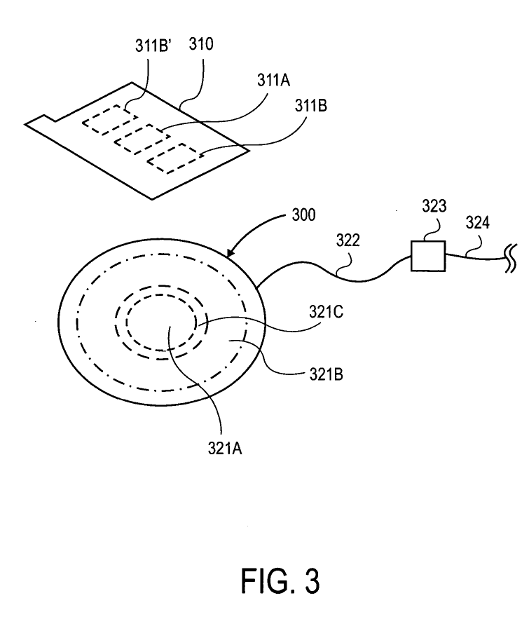

FIG. 3 shows another embodiment of the novel art of this disclosure. Phone 310 may have two or three contacts 311a, 311b, and, optionally, 311b. Circular pad 300 has a center contact zone 321a, an outer contact ring 321b, and a no-contact zone 321c, which lies between zones 321a and 321b. Pad 300 is connected by wire 322 to power supply 323 (may be the same as power supply 123), which in turn plugs in to main ac power source 324.

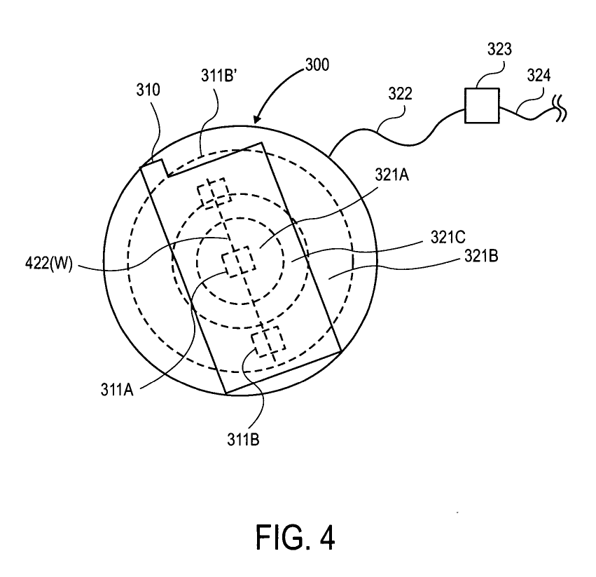

As shown in FIG. 4, in most cases, the phone 310 may be casually set down onto pad 300. Due to the circular nature this embodiment, there is no limit to the omega 422 of alignment of the phone with the pad. Pad 300 may in some cases have a raised edge at its outer perimeter to force the phone into correct contact with the pad; however, there may be a gap of a few millimeters (a quarter-inch to a half-inch) allowing convenient, sloppy application, rather than requiring precise positioning, as is generally required with insertion of a device into a power connector or cradle in current art.

In some cases, due to the small nature of these pads, a plastic clip-on or slip-on cover (not shown) may be used that has openings for the contact pads, allowing the user to customize the look and possibly the feel of the pad. Options could include different colors, flags, transparency, rubbery or fuzzy coatings, etc.

In some cases even additional lighting effects (not shown) may be offered, such as blue pulsing during charge, low-level blue when trickle charging, red flashing when mis-connected, etc. Alternatively, the light color could change to indicate the level of charge, much as some a fuel gauges indicate the fuel level, starting with red or orange (“empty”) and thence progressing to yellow, green and finally blue (everything is “cool”). In some cases the lighting effects and other functions may be added by the user as a plug-in option into an existing, basic passive pad.

Further, many modifications and/or additions may be made without departing from the spirit of the invention. For example, in many cases, typically, a power supply may have a current limit or other protection mechanism, so the pad may be completely passive, to satisfy safety requirements.

Further, in some cases, because a device may have a dc/dc regulator able to accept a wide range of voltages, no issues would occur if there were no exact match. In yet other cases, devices may have a protection mechanism that would pass the power to the device only when the voltage and current are in range, as described earlier in previous applications. In yet other cases, a device may include an automatic polarity routing (e.g., active or passive rectifier bridge). The attached appendices A, B, C, D, E, F, G, H, and I are incorporated herein by reference.

### Non Homogenous Zones in a Free Positioning Power Transfer

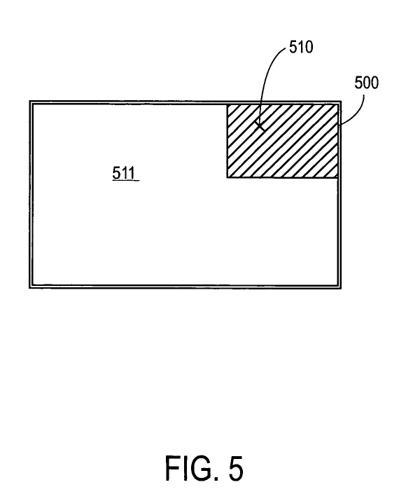

FIG. 5 shows pad 500, with zones 510 and 511. Zone 510 could be for small devices and could be indicated by, for example, yellow coloring; whereas zone 511 could have a more generic color and be intended for larger devices such as, for example, a notebook computer. The contact density of zones 510 and 511 may differ markedly, so that the two zones may contain, for example, the same number of contacts, even though their sizes are substantially different.

In some cases, although the zones may have different electrical and mechanical properties, they can be made similar, such that for the user they look as a consistent surface with only (optional) artificial markings to distinguish between the zones. Further, in some cases zones may overlap or include other zones. For example, the entire surface may be a Notebook zone (i.e. can provide 12-20V and guaranteed to work with large contact spacing) while the right hand portion is also a PDA zone (2-6V and guaranteed to work also with smaller device spacing). In these cases, the PDA zone is included in the notebook zone and therefore a notebook can work on the entire surface.

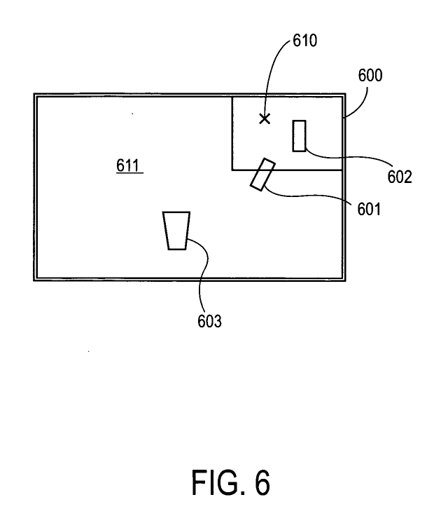

FIG. 6 shows different cell phone positions on pad 600. Cell phone position 601 straddles zones 610 and 611. Thus, if the sensing mechanism cannot recognize the cross zone positioning of the phone and deal with the differing contact densities of the two zones, it may not be able to turn on power, even though it would be technically possible.

Position 602 would be the proper placement location for the cell phone, and thus the power would be turned on. Position 603 would not allow, in many cases the cell phone to be recognized, because, due to the bigger contact area sizes, both cell phone contacts would only touch one pad area. Similarly, a notebook crossing both zones may not be turned on, even though it might be possible to do so.

The size and arrangement of zones 610 and 611 is purely arbitrary. For example, the smaller zone may be a strip along the right edge of the pad, or it may be a border around all the edges, or a strip along the left and the right edges allowing the notebook to be centered and smaller devices placed on either side of the notebook. In other cases, the smaller zone may be at the front or at the back edge of the pad, or it may just be a circle (in the nature of a “hot spot”) within the pad.

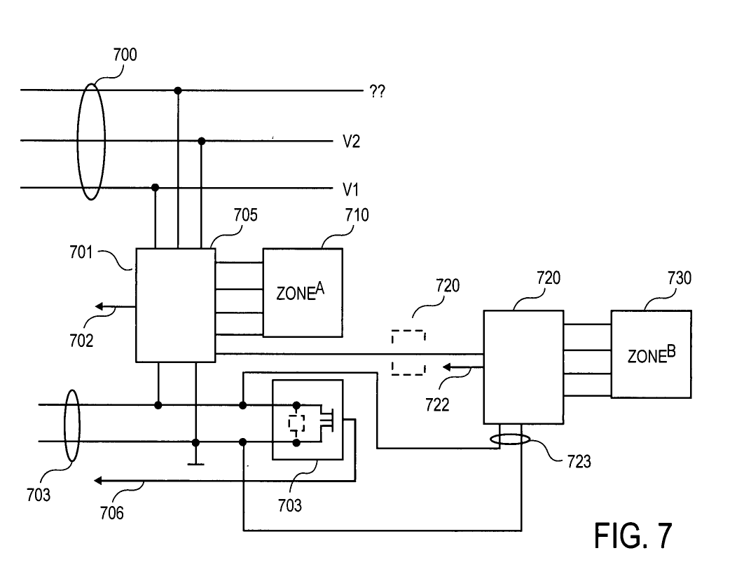

In some cases, a straddling device in a position such as position 201, if recognized properly, may still be operated, even though not completely within one zone. FIG. 7 shows such an approach wherein the first matrix array switch 709 takes voltages from a power supplier lines 700 (coming from power supply, not shown here, but discussed in previous section) and in conjunction with a controller (not shown) via line 702 delivers power on sensing to zone A 310 (i.e., zone 711 of pad 700) and has return lines into the current-sensing circuitry 705 and the ground return line 703.

Off one contact node, a second switch matrix 720 is located. Matrix 720 is also controlled by a controller (not shown) via line 722 and may also have an intermediate additional regulator 724, which in some cases may be programmable by said controller. This second matrix 720 then controls zone B 730, which in the earlier example may be the small area 710 on pad 700. Switch matrix 720 may connect to current sensing circuitry 705 directly, and sense line in supply relay loop 700 through matrix 709.

It is clear that many modifications and variations of this embodiment may be made by one skilled in the art without departing from the spirit of the novel art of this disclosure. For example, power regulator 724 may connect directly to one of the supply areas 700 rather than via primary switching area 709.

In another aspect of the invention, an after market add-on may be offered, that is glued or otherwise mechanically connected to a device, and may offer in some cases multiple geometries, as to allow cross zone operation, i.e. for notebooks (not shown here). In some cases, it may rather connect to a different port than the regular power port, such as a docking port, USB on the go port, or other types of ports facilitating insertion of electrical power into a device (not shown here).

In yet another example, the surface is forcefully separated into zones. That means, even if a smaller device is placed on the large contact zone such that its contacts happen to touch two base contacts, it is intentionally not provided power, in order to it to make the behavior more consistent to the user (so the PDA will work only in the zone designated for PDA's).

Further, the attached adapter may have flexibility built in the adapter body (that is, contacts connected tightly to a flexible base or adapter body) to match the mechanical requirements of each zone.

As is discussed, the device parameters may include information such as device type and category information regarding the device contact geometry, size, spacing, and shape that will be used to enable/disable powering the device on the various zones. In some cases a device compatibility check that does not deliver power to the device if it is not compatible with the surface even if in some condition it may get power from that device. For example, when a small device placed on a surface with large contacts, in some location it may touch two contacts properly in others it will not. In this case, the system will not deliver power at all for consistency. The device geometry parameters may be received for example from the ID chip. Same concept if the surface has designated area for small devices, they will not work on the rest of the surface even if they happen to touch the contacts properly. The attached appendix J is incorporated herein by reference.

1. An apparatus comprising:
A mobile electronic device having two electrical contact zones, the mobile device to be placed on a pad having two contact zones corresponding to the two contact zones of the telephone, the pad receiving electrical power from a power supply, when the two contact zone of the telephone are placed in contact with the two contact zones of the pad an electrical circuit is established.

2. An apparatus comprising:
A pad receiving electrical power from a power supply, the pad including at least two separate groups of electrical contacts zones of separate densities.

3. The apparatus of claim 2, wherein the two different zones are indicated by accordingly differet colors.
